(19) United States
(12) Patent Application Publication
(10) Pub. No.: US 2014/0365325 A1
(43) Pub. Date: Dec. 11, 2014

(54) DIGITALLY SENDING AN ITEM TO A RECIPIENT FROM AN E-COMMERCE SITE

(71) Applicants: Yaacov M. MARTIN, Columbus, OH (US); Shaul H. WEISBAND, Columbus, OH (US)

(72) Inventors: Yaacov M. MARTIN, Columbus, OH (US); Shaul H. WEISBAND, Columbus, OH (US)

(21) Appl. No.: 14/297,676

(22) Filed: Jun. 6, 2014

Related U.S. Application Data
(60) Provisional application No. 61/832,182, filed on Jun. 7, 2013.

(51) Int. Cl. G06Q 30/06

(52) U.S. Cl. CPC G06Q 30/0601; G06Q 30/0605
USPC 705/26.2; 705/26.1

(57) ABSTRACT

A method to provide digital transmission of an item from a shopper to a recipient using an e-commerce website. The method includes adding a “gifting” function by inserting a few lines of code, selecting an item by the shopper and inserting personal details and details of a recipient, activating the “gifting” function and finalizing the purchase of the item. The method also includes receiving authorization by the system, submitting a request via an API to partnering gift card issuers, one of the partnering networks for a closed loop by a particular store or open loop gift card code by a partnering network, digitally sending the code to the recipient, along with an image and other details, receiving the code by the recipient to be used to redeem the item selected by the purchaser or another item and using the code in a corresponding store.

### FIELD OF THE INVENTION

The present invention relates generally to e-commerce applications, and more particularly to the interaction between online gifting and in-store shopping.

### BACKGROUND OF THE INVENTION

The e-commerce checkout process is designed and optimized for shopping, not gifting. When using an e-commerce website, the process of shipping a gift to someone else is even more difficult and actually more cumbersome than shipping to oneself, as in the case of gifting one needs to know the 3^{rd} party's shipping address, including the zip code, etc. This won't match up to the gifter's billing address, and causes complications.

Many people generally enjoy shopping at their favorite brick and mortar stores and malls, trying on clothes or playing with gadgets. However, when shopping/browsing online, they frequently do not actually complete a purchase of the items, regardless of how much they like them. At the same time, these people quite often have friends and family members who would enjoy purchasing something for these people. Typically, without knowing exactly what someone wants, such purchases are given to others as “hit-or-miss” gift items, or the even less personal option of gift cards.

In particular, gift-giving might seem like a routine activity for most people, since gifts account for more than 4% of the typical household budget. However, many people struggle when giving gifts as evidenced by the almost 50% return rate at the. People are more appreciative of gifts they explicitly request; however, existing gift registries tend to focus on certain life events, like weddings and births and are limited to a few stores. Also, gift registries are a costly investment for retailers to develop and maintain.

According to recent e-commerce studies, 59.8% of potential customers abandon their shopping cart. In 2010 a usability study was conducted on a sampling of Web users, focusing only on the checkout user experience, from “Cart” to “Completed order.” The study has shown that it is often difficult to lead customers to the final step in the checkout process when the only thing left is to submit their credit card details.

Among the e-commerce websites tested were: 1-800-Flowers, AllPosters, American Apparel, Amnesty, Apple, HobbyTron, Levi's, Newegg, Nordstrom, Oakley, Perfume.com, PetSmart, Thomann, Walmart and Zappos. The test subjects were given more than 500 usability issues, ranging from being distracted by animated graphics to being thrown off course by an illogical checkout flow. One conclusion is that the Checkout Process Should Be Completely Linear. Websites with a non-linear checkout process left test subjects confused and intimidated.

Without descriptions, form field labels can be ambiguous. For example, what does “Address line 2” mean?” a test subject mumbled. Other test subjects were confused by “Billing address.”

Currently, it is difficult and stressful to choose and send items/gifts for the following reasons:

1. Shipping costs;
2. Choosing the appropriate item and it's properties;
3. Delay between the time of purchase and delivery; and
4. Sending funds is risky.

In order to add a new gifting function to an existing e-commerce website, generally there is a need for integration of additional lines of website coding. This requirement for integration may discourage the adaptation of this function to existing websites.

Thus, it would be advantageous to provide a solution that does not require integration of additional lines of website coding into existing gifting applications in use by e-commerce websites and overcomes other prior art difficulties.

### SUMMARY OF THE INVENTION

Accordingly, it is a principal object of the present invention to provide a solution that does not require integration into existing gifting applications in-use by e-commerce websites.

It is another principal object of the present invention to enable shoppers to send gifts right from an e-commerce provider's website without ever having to confront the known gifting barriers: shipping address and product details, such as model/color/style/size.

It is one other principal object of the present invention to enable online shoppers to purchase and digitally transmit an item/gift to a recipient for redemption.

It is still another principal object of the present invention to overcome problems inherent in the experience of gifting and/or chipping-in for the purchase/redemption of any item.

It is one more principal object of the present invention to enable the gift recipient to decide whether to redeem the gift online or in-store, while selecting the perfect model, color and style, thereby eliminating returns and bad gifts.

A method is disclosed to provide digital transmission of an item from a shopper to a recipient using an e-commerce website. The method includes adding a “gifting” function by inserting a few lines of code, selecting an item by the shopper and inserting personal details and details of a recipient, activating the “gifting” function and finalizing the purchase of the item. The method also includes receiving authorization by the system, submitting a request via an API to partnering gift card issuers, one of the partnering networks for a closed loop by a particular store or open loop gift card code by a partnering network, digitally sending the code to the recipient, along with an image and other details, receiving the code by the recipient to be used to redeem the item selected by the purchaser or another item and using the code in a corresponding store.

In accordance with the present invention, by inserting a couple of lines of code into any e-commerce site, shoppers will be able to choose to purchase and send any item viewed on the site directly to any recipient's smartphone, email or any other digital account. The recipient will digitally receive an image and/or description of the item, along with a redemption code that will redemption of the item in-store or online. The recipient can then choose the properties of the item or use the code to redeem the item or another item in-store or online. The present invention facilitates the “posting” of this gift on social media channels such as Facebook, so the recipient's friends can see that the recipient was gifted, but access is only allowed to the recipient. As further described herein the friends “chip-in” to the purchase of the gift.

Within the overlay or i-frame that is extended as a result of pressing on the “gift-it” button the present invention provides the checkout as well. This is separate from the retailer's general checkout, and thus does not require any integration. Also, since the gifting process is quite different from the self checkout, this separate checkout is advantageous and creates a smooth and streamlined process.

The e-commerce site need not integrate any additional components/technology other than the added code that provides a “gift-it” button. The technology knows how to process the purchase and then convert the funds received into a redeemable voucher, accompanied by the item's image and some properties. The technology produces a point-of-sale (POS) recognized code.

The present invention allows additional and innovative functionality with the insertion of minimal code to an existing e-commerce site.

The present invention enables a user to send an item/gift in real time.
The present invention eliminates the need and/or for shipping.
The present invention maintains flexibility on the recipient's end.
The present invention allows for in-store and/or online redemption.

### Chip-in and Split Tender

This feature allows for friends to contribute towards a gift, usually a “high ticket item.” The friend can either set the amount by dragging an indicator on a bar or simply edit the amount that being contributed.

Normally, the issue with “group gifting” or “chipping in” as a group for a larger item faces the challenge of the group not having reached the goal and then the question is whether the transactions are all voided, refunded etc. In this case, since the funds are basically transferred in one form or another to the recipient in a “dollar value.” The recipient can be allowed to “cash-in” at any given moment and use the accumulated funds towards an item of choice. Also, the retailers are generally setup for a “split tender” in which case the recipient can decide to complete the outstanding funds him/herself. In this case for example, the recipient would walk into a store, although this can be achieved online as well, and show the digital code for a certain portion of the item price and use another payment method for the outstanding funds.

Adding the “Gift it” Button by the Retailer and the “Browser Extension” Option

Ideally the “gift-it” solution can be introduced to a retailer for implementation in their native e-commerce site. Nevertheless, it is possible to “fit” the “gift-it” button onto an existing site without the intervention of the site-owner/retailer by using a browser extension/add-on. This is a “widget” of sorts that is downloaded and installs itself as an “app” of sorts, functioning within the internet browser. This extension would then ensure that a “gift-it” button appears locally on a pre-determined list of sites. The advantage is that this can be done without any intervention on the retailers end. However, this approach requires a substantial additional step to be taken by the user and therefore may not be as widely used.

Groups of people or businesses that would benefit from the invention include e-commerce sites, retailers, online shoppers, gift givers and parents funding a child's purchase. Retailers and e-commerce sites will allow their shoppers to send an item to anyone immediately. The recipients will receive a thoughtful item/gift but retain the flexibility, similar to a gift card. Also the present invention enables parents to more effectively control child spending.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

For a better understanding of the invention with regard to the embodiments thereof, reference is now made to the accompanying drawings, in which like numerals designate corresponding elements or sections throughout, and in which:

FIG. 1 is an illustration of the few lines of code that are implemented, constructed according to the principles of an embodiment of the present invention;

FIG. 2 is an illustration of the added button—in this case “gift it,” constructed according to the principles of an embodiment of the present invention;

FIG. 3 is an illustration of the pop-up that appears when the new button is pressed, constructed according to the principles of an embodiment of the present invention;

FIG. 4 is a flow diagram of the process, constructed according to the principles of an embodiment of the present invention;

FIG. 5 is a detailed technical illustration of the processes that take place behind the scenes, constructed according to the principles of an embodiment of the present invention;

FIG. 6 is an illustration of one of the possible redemption modes, in this case presented in a store on a mobile device, constructed according to the principles of an embodiment of the present invention;

FIG. 7 is a screenshot illustration of the chip-in invitation page, constructed according to the principles of an embodiment of the present invention;

FIG. 8 is a screenshot illustration of the chip-in announcement, constructed according to the principles of an embodiment of the present invention;

FIG. 9 is a screenshot illustration of the chip-in pop-up, constructed according to the principles of an embodiment of the present invention; and

FIG. 10 is a screenshot illustration of the chip-in invitation pop-up, constructed according to the principles of an embodiment of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

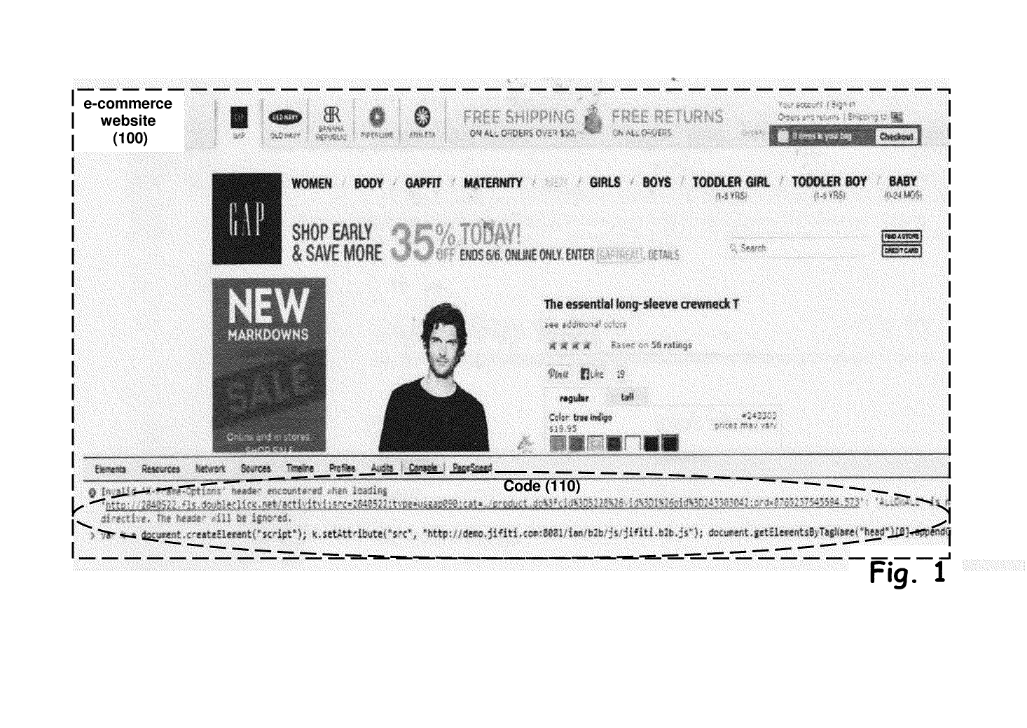

FIG. 1 is an illustration of the few lines of code 110 that are implemented on an e-commerce website 100, constructed according to the principles of an embodiment of the present invention.

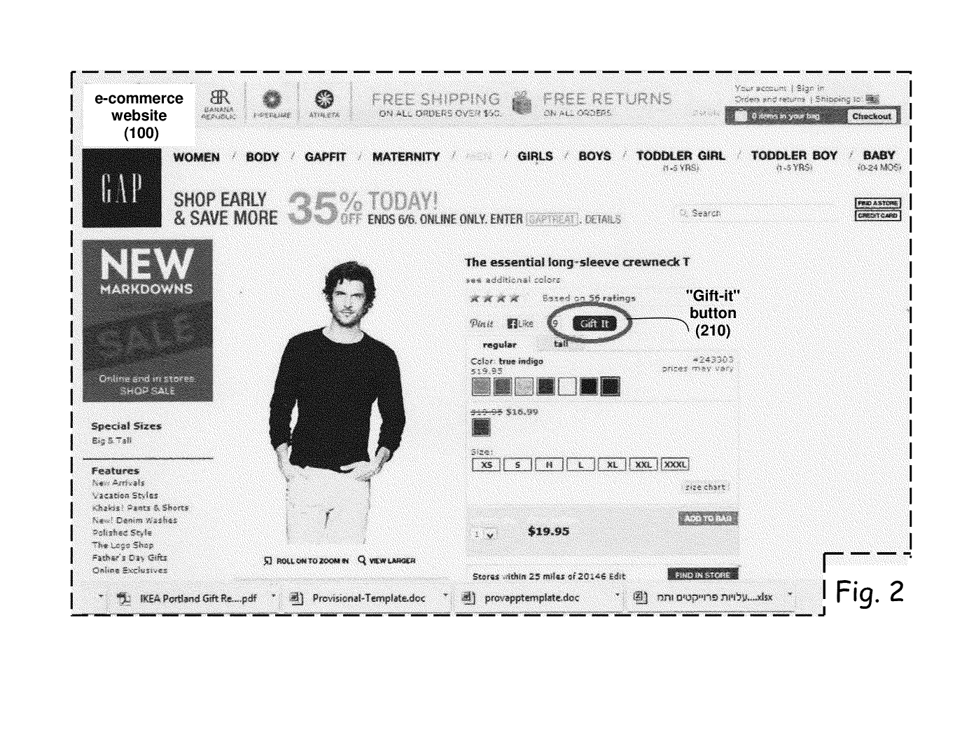

FIG. 2 is an illustration of the added “gift it” button 210 implemented on the e-commerce website 100 of FIG. 1, constructed according to the principles of an embodiment of the present invention.

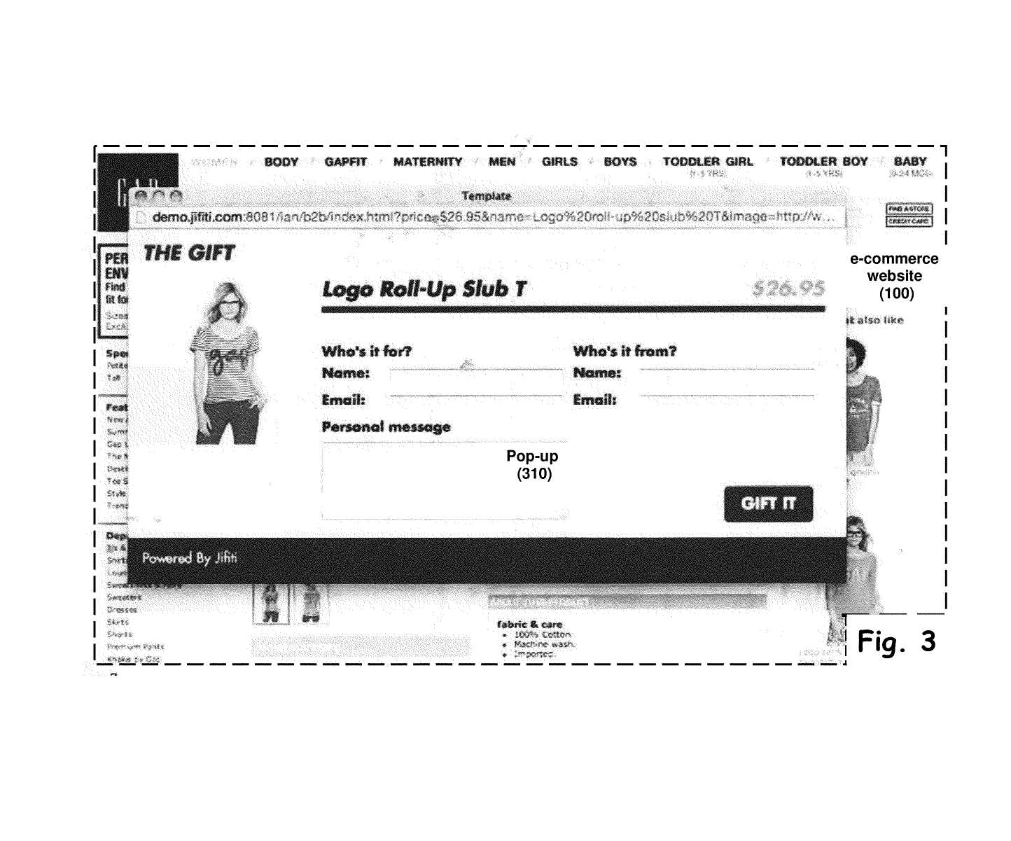

FIG. 3 is an illustration of the pop-up 310 that appears on the e-commerce website 100 of FIG. 1 when the “gift it” button 210 of FIG. 2 is pressed, constructed according to the principles of an embodiment of the present invention.

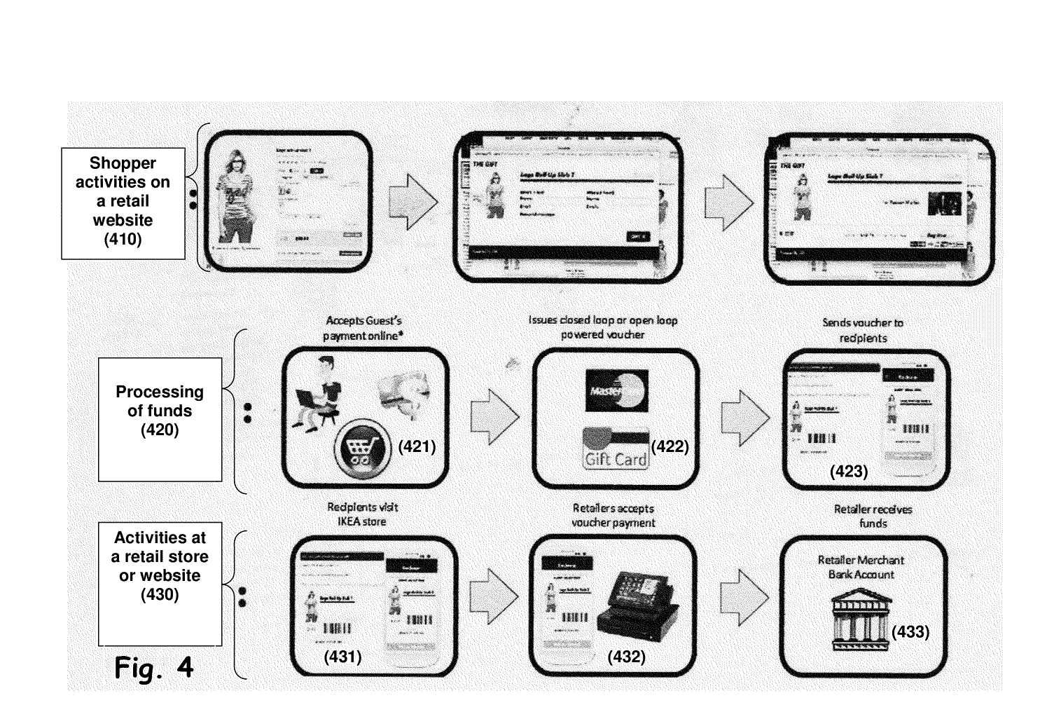

FIG. 4 is a flow diagram of the process, constructed according to the principles of an embodiment of the present invention. The top row 410 shows a sequence of shopper activities on a retail website. The middle row 420 shows the sequence for the processing of funds: the website screen 421 accepts the guest's payment online; the website screen 422 issues a closed loop or open loop powered voucher; and the website screen 423 sends the voucher to the recipients of the gift. The bottom row 430 shows the activities at a retail store or website: the recipients visit an IKEA store at screen 431; the retailer accepts voucher payment at screen 432, and receives the funds at screen 433.

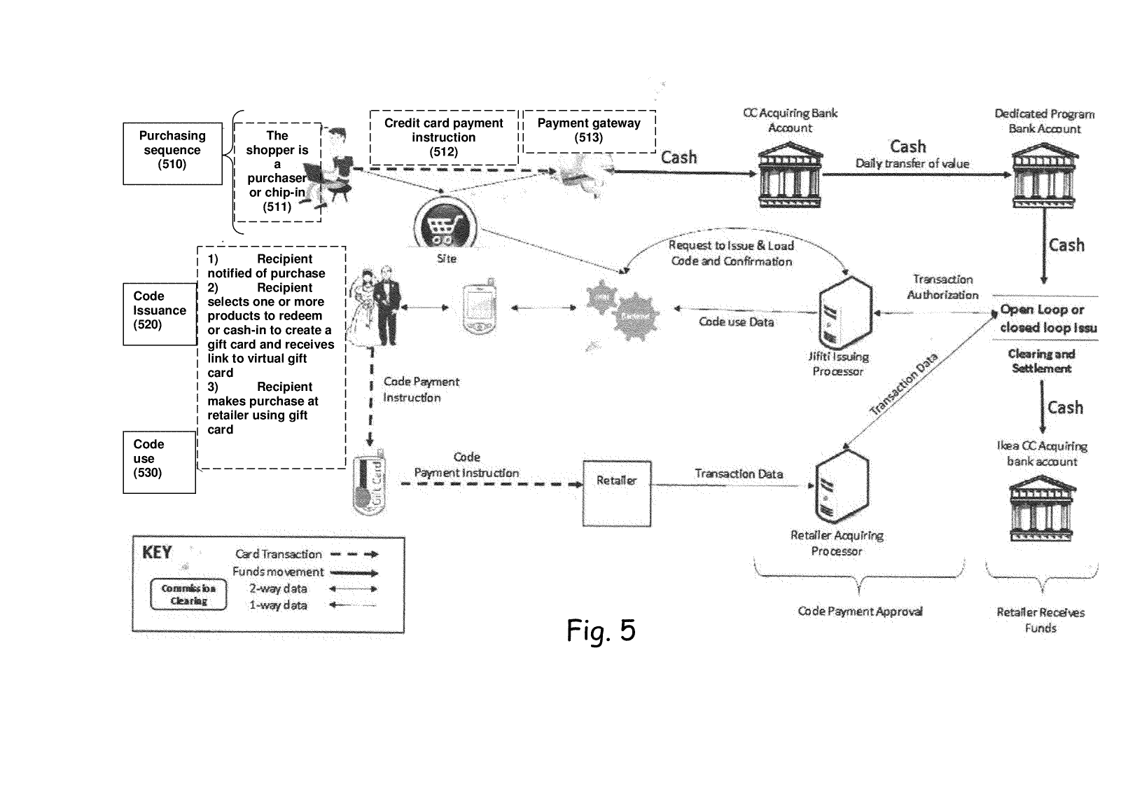

FIG. 5 is a detailed technical illustration of the processes that take place behind the scenes, constructed according to the principles of an embodiment of the present invention. The first row 510 shows the purchasing sequence. The shopper is a purchaser or chip-in participant through a social network 511. Credit card payment instructions 512 are passed on to the payment gateway 513.

The second row 520 shows the sequences for voucher/code issuance.

1. Recipient is notified of the purchase;
2. Recipient selects one or more products to redeem or cash-in to create a gift card and receives link to virtual gift card; and
3. Recipient makes purchase at retailer using gift card.

The third row 530 shows how the voucher/code is used.

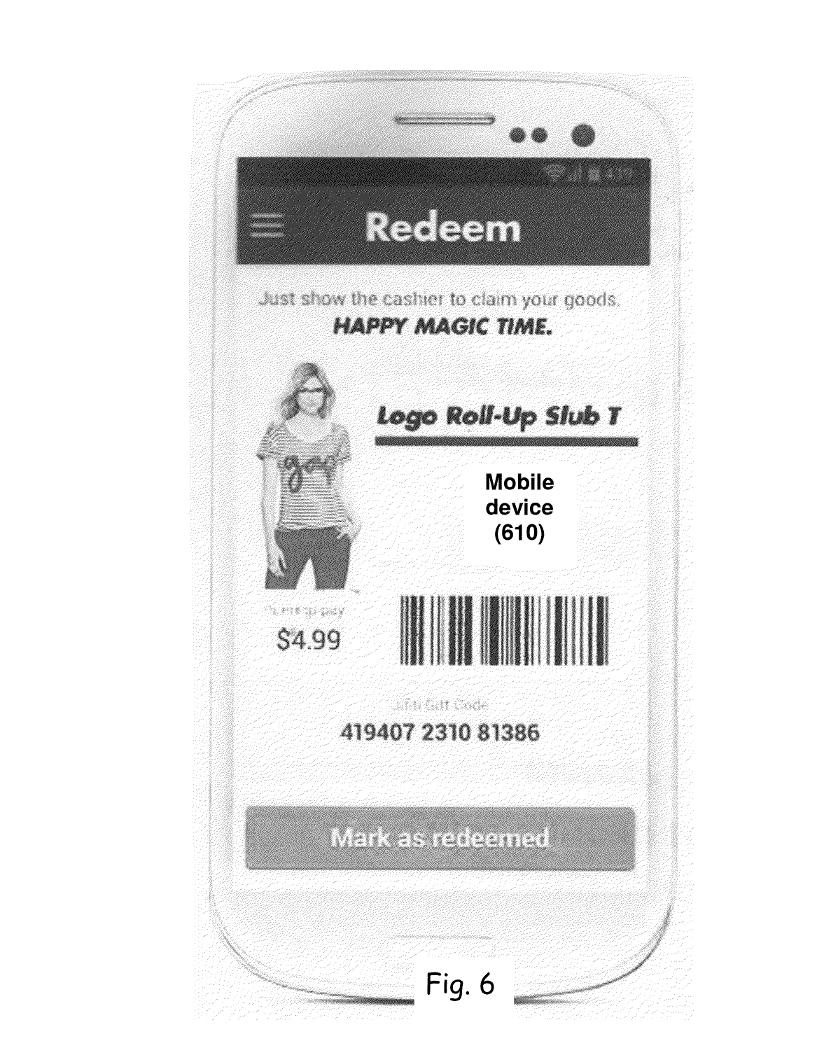

FIG. 6 is an illustration of one of the possible redemption modes, in this case presented in a store on a mobile device 610, constructed according to the principles of an embodiment of the present invention.

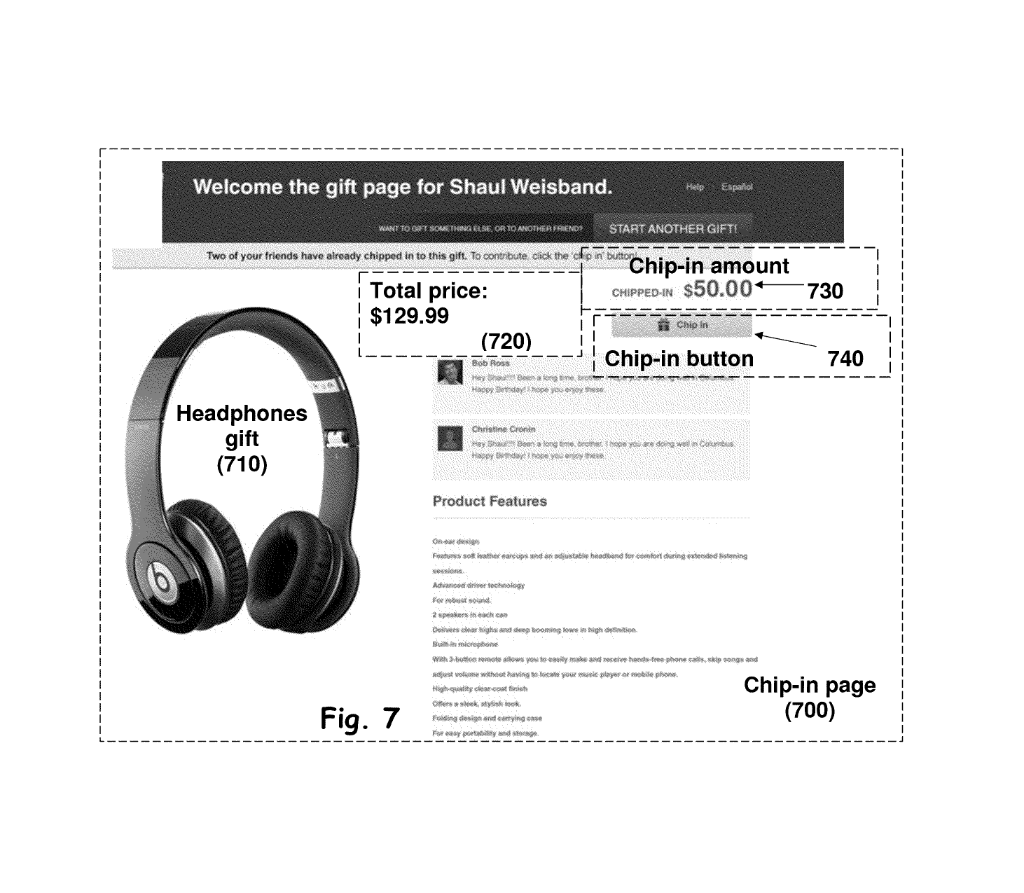

FIG. 7 is a screenshot illustration of the chip-in invitation page, constructed according to the principles of an embodiment of the present invention. Friends and family, who are invited to ‘Chip-In,’ will receive a link to a personalized landing page, where they can easily ‘Chip-In’ and leave a personal message. Chipping-in will take the user through this flow. For example, a gift of headphones is shown 710, the total price 720 of headphones 710, the individual chip-in amount 730 and the chip-in button 740.

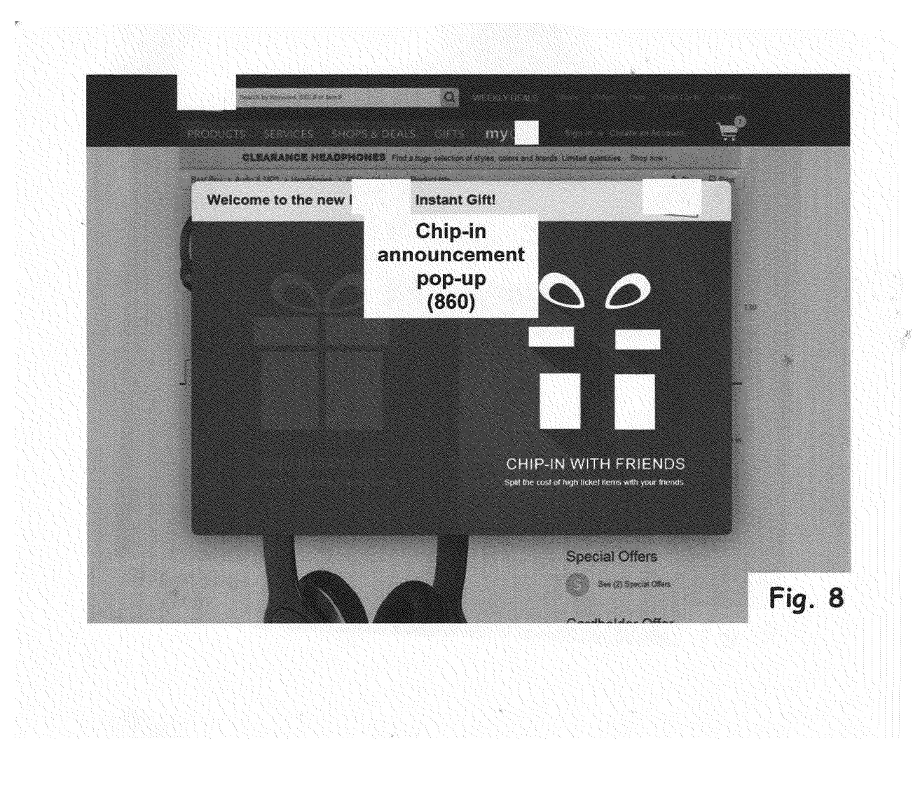

FIG. 8 is a screenshot illustration of the chip-in announcement 860, constructed according to the principles of an embodiment of the present invention. Clicking the Gift-it button opens a separate check-out overlay. The user can select to purchase the entire gift himself, or invite friends to chip-in.

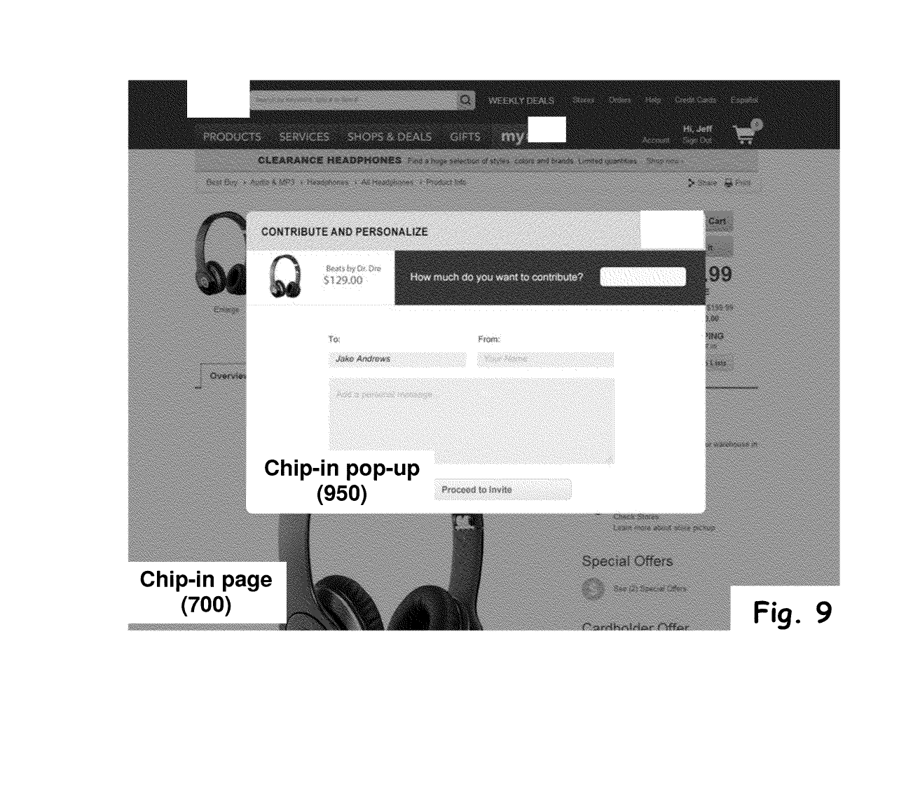

FIG. 9 is a screenshot illustration of the chip-in pop-up, constructed according to the principles of an embodiment of the present invention. When the invitee clicks the chip-in button 740 on the chip-in page 700 of FIG. 7, the chip-in pop-up 950 appears. Upon selecting ‘Chip-In,’ the user selects the amount to contribute, who it's for and from, and is encouraged to add a personal gift message.

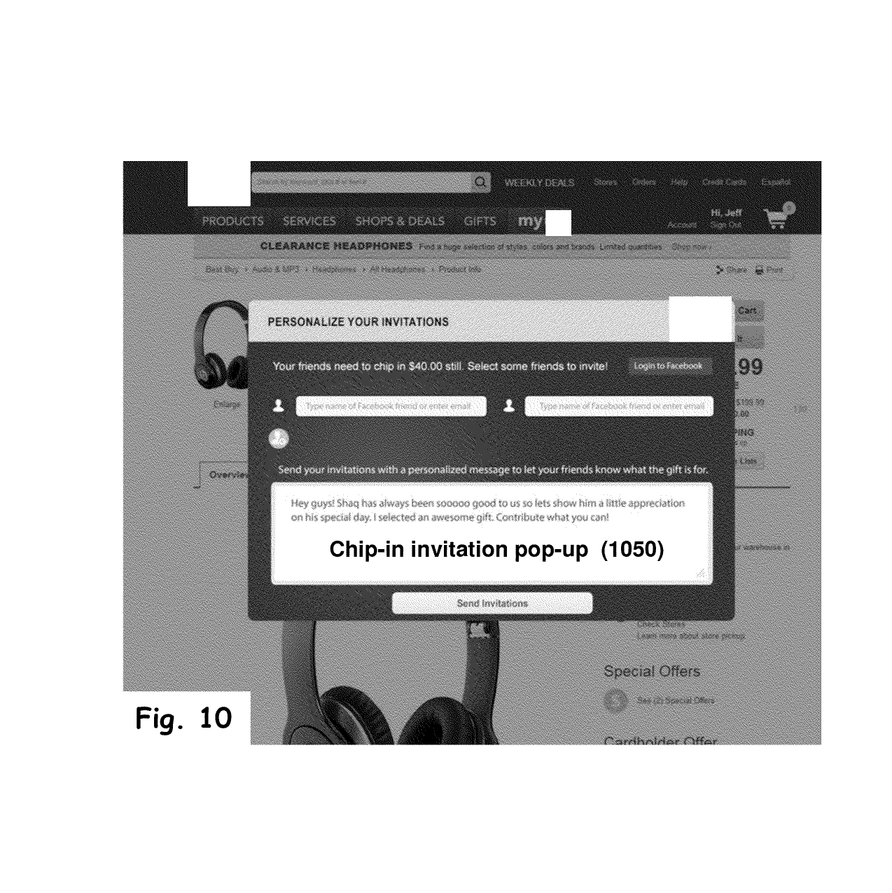

FIG. 10 is a screenshot illustration of the chip-in invitation pop-up 1050, constructed according to the principles of an embodiment of the present invention. The user invites friends to chip-in for the item via e-mail or social networks.

By inserting a few lines of code into an e-commerce website the present invention is able to offer a function of digitally transmitting an item to a recipient. Once the code is implemented, the site will present an additional option by any item sold on the site. This button may be titled “gift” or “send” etc. Once pressed, an overlay or pop-up appears and allows the shopper to select the item and insert his/her details along with the details of a recipient including the recipient's email address. The overlay/pop-up then guides the shopper through the process of finalizing the purchase of the items via any of the popular payment methods (major credit and/or debit card networks, Paypal etc.).

Once the purchase is finalized and the system receives authorization for the transaction, the system submits a request via an API to one the partnering gift card issuers or one of the partnering networks for a closed or open loop gift card voucher/code representing the funds that were put towards the purchase. Once received, the system sends the code to the recipient via email, or otherwise digitally, along with an image and other details concerning the item that was selected and purchased by the purchaser.

The recipient may view the image and details and/or may view an animation of the item/gift unwrapping digitally and will then receive the code in the form of numbers and/or bar code to be used to redeem the item selected by the purchaser or another item. The recipient may use the code in a corresponding store and by keying in or scanning the code the redemption may be completed in the store. In addition, in some cases, the code may be used on a corresponding e-commerce site to redeem and order the item selected by the purchaser or another item. The store's POS or e-commerce's site and/or payment gateway will accept the code as a means of payment.

In accordance with the principles of the present invention, the website code is added in the appropriate section of the e-commerce website. The code communicates with the system which may be hosted locally or otherwise. The code allows for the populating of additional functionality and for the system to power a popup/overlay as an additional layer or otherwise on the website. Through this pop-up overlay or otherwise, the relevant information, including, but not limited to purchaser's details, recipient's details, message and any other information, is provided, and a purchase may be completed. The pop-up/overlay or otherwise can direct the user to the payment gateway which may be hosted locally or otherwise. The payment gateway will process the purchase. The payment gateway will then notify the system as to the details of the purchase.

The system will receive the data concerning the purchase, and if appropriate will submit a request to an external (or otherwise) issuer for the issuance of a closed loop gift card or an open loop gift card corresponding with the data, particularly the purchase sum. A closed loop gift card is a system of codes that represents a specific brand or retailer's currency. Therefore these codes are issued by the retailer, usually through a 3^{rd} party, and can be used to redeem merchandise at any of the brand's stores, only, and usually on the website as well.

These closed loop gift cards are usually handled, issued and distributed by 1 of 3 major gift card companies in the US. The present invention is integrated with the major ones, and therefore is able to issue these codes in real time through API integration with the gift card issuing company.

An open loop gift card is basically a code issued by one of the major networks (Visa, MasterCard, American Express, etc.). These codes are usually redeemable anywhere the network is accepted. These open loop gift cards are normally physical and look identical to a physical credit/debit card plastic card with some graphic/branding (e.g., Delta American Express). Sometimes, these open loop gift cards are offered in digital form to be used online/via telephone. The present invention has received a “variance” from Mastercard allowing for the issuance of a digital MasterCard code to be used both in-store and online.

These two methods allow the present invention to offer its solutions to retailers without the need of integrating with their POS (Point of Sale) systems. In the closed loop scenario this is because the present invention has integrated with the issuing company and therefore is issuing codes that are already recognized by the retailer's POS. In the open loop scenario the present invention is issuing essentially a MasterCard code and this too is recognized by all POS's.

The issuer will return a code representing the data requested. The system will match the code with other details concerning the purchase (such as image, title, message etc. . . . ) and/or the item/gift and will send the code along with the data above to the recipient digitally. The recipient will receive the data above in a digital manner and will use the images and/or numbers to redeem the item or another item in a corresponding store or on a corresponding e-commerce site.

As described heretofore, the present invention provides a system that:
1. Supports/Partners with a payment gateway
2. Supports/Partners with a closed loop gift card/issuer and/or an open loop gift card issuer.
3. Recognizes item details and images and is able to capture and transmit to a recipient digitally.
4. Identifies stores/e-commerce sites that recognize the codes being issued by the closed loop gift card/issuer and/or an open loop gift card issuer.
5. Provides a website code that can operate all of the above on an existing e-commerce website.

### ALTERNATIVE EMBODIMENTS OF THE INVENTION

The present invention can be used to monitor and control spending of a dependent. The invention can be used to transmit funds. The present invention can be used to select and save items while browsing an e-commerce site.

Having described the invention with regard to certain specific embodiments thereof, it is to be understood that the description is not meant as a limitation, since further embodiments and modifications will now become apparent to those skilled in the art, and it is intended to cover such modifications as fall within the scope of the appended claims.

We claim:

1. A method to provide digital transmission of an item from a shopper/purchaser to a recipient using an e-commerce website, the method comprising:
adding a “gifting” function to an e-commerce website by the owner by inserting a few lines of code;
accessing the e-commerce website for purposes of purchasing and sending a gift by a shopper/purchaser;
selecting an item by the shopper/purchaser and inserting personal details along with the details of a recipient, the details at least comprising the recipient's email address, and wherein the overlay/pop-up then guides the shopper through the purchase process;
activating the “gifting” function by the shopper/purchaser, subsequent to which an overlay/pop-up appears;
finalizing the purchase of the items via any payment method;
receiving authorization for the transaction by the system;
submitting a request by the system via an application program interface (API) to at least one of: partnering gift card issuers; one of the partnering networks for a closed loop by a particular store; and open loop gift card code by a partnering network, representing the funds that were put towards the purchase;
digitally sending the code by the system to the recipient, along with an image and other details concerning the item that was selected and purchased by the shopper/purchaser;
receiving the code in the form of numbers and/or bar code by the recipient to be used to redeem the item selected by the purchaser or another item; and
using the code in a corresponding store and by keying in or scanning the code the redemption may be completed in the store.

2. The method of claim 1, wherein the payment method comprises one of a major credit, a debit card networks and Paypal.

3. The method of claim 1, wherein digital sending the code is via email.

4. The method of claim 1, further comprising viewing by the recipient of the image and/or details.

5. The method of claim 1, further comprising viewing by the recipient of an animation of the item/gift, and/or unwrapping digitally of the item.

6. A tangible, non-transitory, computer-readable media having software encoded thereon, the software when executed by a processor operable to: adding a “gifting” function to an e-commerce website by the owner by inserting a few lines of code;
accessing the e-commerce website for purposes of purchasing and sending a gift by a shopper/purchaser;
selecting an item by the shopper/purchaser and inserting personal details along with the details of a recipient, the details at least comprising the recipient's email address, and wherein the overlay/pop-up then guides the shopper through the purchase process;
activating the “gifting” function by the shopper/purchaser, subsequent to which an overlay/pop-up appears;
finalizing the purchase of the item via any payment method;
receiving authorization for the transaction by the system;
submitting a request by the system via an application program interface (API) to at least one of: partnering gift card issuers; one of the partnering networks for a closed loop by a particular store; and open loop gift card code by a partnering network, representing the funds that were put towards the purchase;
digitally sending the code by the system to the recipient, along with an image and other details concerning the item that was selected and purchased by the shopper/purchaser;
receiving the code in the form of numbers and/or bar code by the recipient to be used to redeem the item selected by the purchaser or another item; and
using the code in a corresponding store and by keying in or scanning the code the redemption may be completed in the store.

7. The computer-readable media as in claim 6, wherein the software is executed as an app on a personal device of the user, wherein the app is presented as a graphical user interface to the user on the personal device.

8. The computer-readable media as in claim 6, wherein the software is executed as a process on a server in remote communication with a user interface app on a personal device of the user.

9. The computer-readable media as in claim 8, wherein the software when executed is further operable to: provide real-time monitoring of one or more apps within a store of the particular merchant.

10. The computer-readable media as in claim 8, wherein the software when executed is further operable to: provide shopping analytics to the particular merchant based on users sharing products.

11. A method to provide digital transmission of an item from a shopper/purchaser to a recipient using an e-commerce website, the method comprising:
accessing the e-commerce website for purposes of purchasing and sending a gift by a shopper/purchaser;
selecting an item by the shopper/purchaser and inserting his/her details along with the details of a recipient, the details at least comprising the recipient's email address, and wherein the overlay/pop-up then guides the shopper through the purchase process;
activating a “gifting” function by the shopper/purchaser, subsequent to which an overlay/pop-up appears;
finalizing the purchase of the item via any payment method;
receiving authorization for the transaction by the system;
submitting a request by the system via an application program interface (API) to at least one of: partnering gift card issuers; one of the partnering networks for a closed loop by a particular store; and open loop gift card code by a partnering network, representing the funds that were put towards the purchase;
digitally sending the code by the system to the recipient, along with an image and other details concerning the item that was selected and purchased by the shopper/purchaser;
receiving the code in the form of numbers and/or bar code by the recipient to be used to redeem the item selected by the purchaser or another item; and
using the code in a corresponding store and by keying in or scanning the code the redemption may be completed in the store.

12. The method of claim 11, further comprising adding the gifting function to an e-commerce website by the owner by inserting a few lines of code.

13. The method of claim 11, further comprising adding the gifting function to an e-commerce website by a browser extension.

14. The method of claim 11, further comprising inviting at least one other person to chip-in for the gift.
